(19) United States
(12) Patent Application Publication
(10) Pub. No.: US 2008/0022415 A1
(43) Pub. Date: Jan. 24, 2008

(54) Authority limit management method

(76) Inventors: Yu-Chiun Kuo, Taipei (TW); Tsang-Yi Chen, Taipei (TW); Yu-Chang Tseng, Taipei (TW); Liang-Chen Wu, Taipei (TW); Hsieh-Chun Chen, Taipei (TW); Pei-Yin Wu, Taipei (TW); Zechary Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/455,766

(22) Filed: Jun. 20, 2006

(51) Int. Cl. G06F 17/30

(52) U.S. Cl. 726/31

(57) ABSTRACT

An authority limit management method is proposed for a digital media storage. The digital media storage includes at least one micro processor and at least one memory unit and connected to an access device. A classification authorization code index (CAC index) and a plurality of classification operation commands (COC) is pre-stored in the digital media storage and an identification code is set for the access device. The classification operation commands is performed to calculate a classification authorization code when the digital media storage is connected to the access device for initial transmission protocol. The authority limit of the memory unit for the access device is granted to the access device according to the classification authorization code. Therefore, the data of the digital media storage can be prevented from illegal copy or hacker.

### BACKGROUND OF THE INVENTION

1. Field of the Invention

The present invention relates to a method for managing authority limit for digital media storage, especially to a method for managing authority limit for digital media storage by authorizing an access device, thus protecting digital rights management (DRM).

2. Description of the Prior Art

The storage size of storage media is rapidly increased as the progress of digital technology. For example, hard disk, optical storage media (MD, CD-RW, and DVD±RW), USB storage and flash card are developed with larger size. The flash cards comprises CF (Compact Flash), SM (Smart Media), SD (Secure Digital), MMC (Multi Media Card), xD (xD-Picture Card) and MS (Memory Stick).

The above-mentioned digital storage has compact size and large storage capacity. However, the accessing of the digital storage is generally opened and not protected. Therefore, data encryption and decryption mechanism is developed for user authorization and Digital Rights Management (DRM).

The current protection mechanism is intended to protect the digital data instead of digital media storage. Moreover, some protection mechanism uses new hardware standard or storage format for protection, such as Content Protection for Recordable Media (CPRM) for SD card. However, the digital storage media with CPRM format cannot be compatible with other accessing devices.

Moreover, the Digital Rights Management is generally used to protect optical disk such as movie disk or game disk. However, the optical disks pro se do not have computation ability and some software is available to crack the copyright for illegal copy. The optical disks with Digital Rights Management have no ability to judge the authorization of an access apparatus. Moreover, the digital content in read-only optical disk cannot be updated. It is waste of resource.

It is desirable to solve above-mentioned problem and provide authority limit management method is proposed for a digital media storage. The digital media storage has computation ability and can perform initial transmission protocol with an access device. The digital media storage can grant authority limit of access to the access device according to authorization information of the access device. Therefore, the authority limit management method can enhance data security.

### SUMMARY OF THE INVENTION

It is the object of the present invention to provides an authority limit management method for a digital media storage, whereby the digital media storage can grant authority limit to an access device to protect data therein.

Accordingly, the present invention provides an authority limit management method for a digital media storage. The digital media storage includes at least one micro processor and at least one memory unit and connected to an access device. A classification authorization code index (CAC index) and a plurality of classification operation commands (COC) is pre-stored in the digital media storage and an identification code is set for the access device. The classification operation commands (COC) is performed to calculate a classification authorization code when the digital media storage is connected to the access device for initial transmission protocol. The authority limit of the memory unit for the access device is granted to the access device according to the classification authorization code. Therefore, the data of the digital media storage can be prevented from illegal copy or hacker.

Accordingly, the present invention provides a digital media storage connected to an access device with an identification code. The digital media storage comprises at least one memory unit and at least one micro processor. The memory unit is used to store data and pre-stored with a classification authorization code index (CAC index) and a plurality of classification operation commands (COC). The micro processor performs the classification operation commands (COC) and calculates a classification authorization code according to the identification code of the access device. The micro processor determines an authority limit of the memory unit for the access device according to the classification authorization code and controls an operation and range for accessing the memory unit.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a system with method for authorization management according to the present invention.

FIG. 2 shows a block diagram of digital media storage with authorization classifications.

FIG. 3 shows the authorization flowchart of the present invention.

FIG. 4 shows the schematic diagram of the hybrid code.

### DETAILED DESCRIPTION OF THE INVENTION

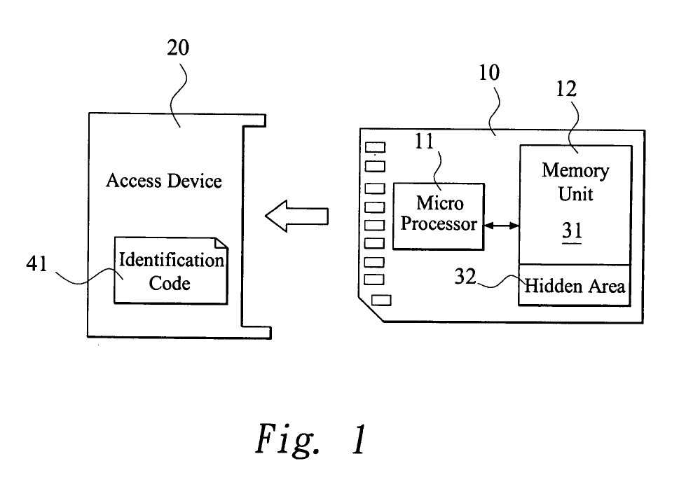

FIG. 1 shows a system with method for authorization management according to the present invention, where an SD card is used. A digital media storage 10 with method for authorization management according to the present invention has the ability of Digital Rights Management (DRM) and enable user to protect his confidential data. The digital media storage 10 is connected to an access device 20 to read and write the digital media storage 10.

The digital media storage 10 according to the present invention is a storage with compact size such as flash card with flash memory, USB storage with flash memory, or hard disk. The access device 20 can be a flash card reader, a USB device with USB interface, or a PC.

When the digital media storage 10 is a flash card, the flash card can be CF (Compact Flash), SM (Smart Media), SD (Secure Digital), MMC (Multi Media Card), xD (xD-Picture Card) or MS (Memory Stick).

The present invention assigns a specific identification code 41 for each access device 20. The identification code 41 comprises a device code for the access device 20 and a classification authorization code 43 for representing its authority limit. The identification code 41 for each access device 20 is decrypted to find the device code and the classification authorization code 43. The device code and the classification authorization code 43 are calculated to authorize permission for the access device 20. Therefore, the digital media storage 10 can identify the access device 20 and authorizes the read/write permission to the access device 20.

For example, a digital media storage with movie file can provide the playback of Media Player; while PC and media recorder cannot access the digital media storage with movie file to protect digital rights.

The present invention can be used for a GPS navigator of a specific manufacturer. The GPS navigator comprises navigator software and related information. The navigator software and related information can only be read by the GPS navigator of the specific manufacturer, and cannot be read by other manufacturers.

The digital media storage 10 comprises at least one micro processor 11 and at least one memory unit 12. The micro processor 11 controls a transmission protocol for the access device 20. The micro processor 11 further controls read/write operation for the memory unit 12 and the read/write range for the memory unit 12.

The memory unit 12 is flash memory or a hard disk. The memory unit 12 comprises one or more than one readable/recordable area 31 and a hidden area 32. The readable/recordable area 31 is used for data storage and the accessing options of the readable/recordable area 31 can be set as Readable/Recordable, Readable/Non-recordable, or Non-readable/Non-recordable.

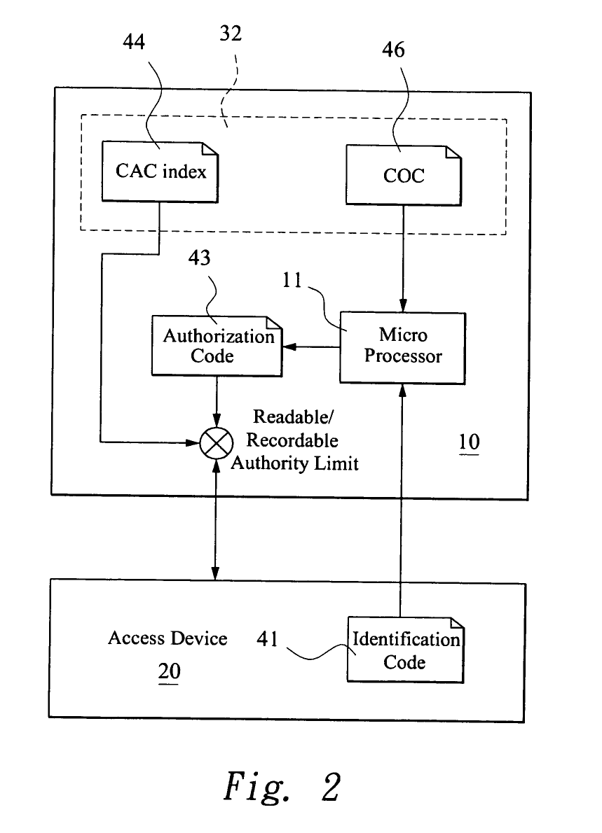

FIG. 2 shows a block diagram of digital media storage with authorization classifications. The hidden area 32 can be read, written or modified only through specific program or hardware by the original manufacturer, and cannot be read or previewed by other hardware. The hidden area 32 comprises a classification authorization code index (CAC index) 44, a storage ID code (SIDC) 45 and a plurality of classification operation command (COC) 46. The pre-stored data in the hidden area 32 is stored before leaving the factory. Alternatively, the pre-stored data in the hidden area 32 is stored by updating from original manufacturer.

The CAC index 44 stores the device code and the classification authorization code 43 of the access device 20. The identification code 41 is a unique serial number for the access device 20. The classification operation command (COC) 46 is used to compute with SIDC 45 and the classification authorization code index (CAC index) 44.

When the digital media storage 10 is connected to the access device 20, or the digital media storage 10 and the access device 20 are turned after connection, the digital media storage 10 and the access device 20 will perform initial transmission protocol. The access device 20 sends an identification code 41 to the digital media storage 10. The digital media storage 10 performs the classification operation command (COC) 46 to decrypt the identification code 41 to obtain the device code and the classification authorization code 43. The device code is compared with record in the CAC index 44. If the device code is matched, the authority limit is determined according to the classification authorization code 43, by which the access device 20 accesses the digital media storage 10.

To prevent hacker of the classification authorization code 43, an authorization mechanism performed by both parties is proposed. Because both of the access device 20 and the digital media storage 10 have computation ability, the classification authorization code 43 and the storage ID code 45 are ciphered to obtain a hybrid code (HC) 47. The access device 20 is granted for readable/recordable permission when the hybrid codes are matched. Therefore, the access device 20 can perform read/write operation to the digital media storage 10. Therefore, the hybrid code 47 cannot be obtained if only the classification authorization code 43 is hackered. In other word, the hybrid code 47 cannot be obtained after the classification authorization code 43 and the classification operation command (COC) 46 are hackered, as long as the storage ID code 45 is not matched, where the storage ID code 45 is matched for specific serial numbers. Therefore, digital rights management can be ensured.

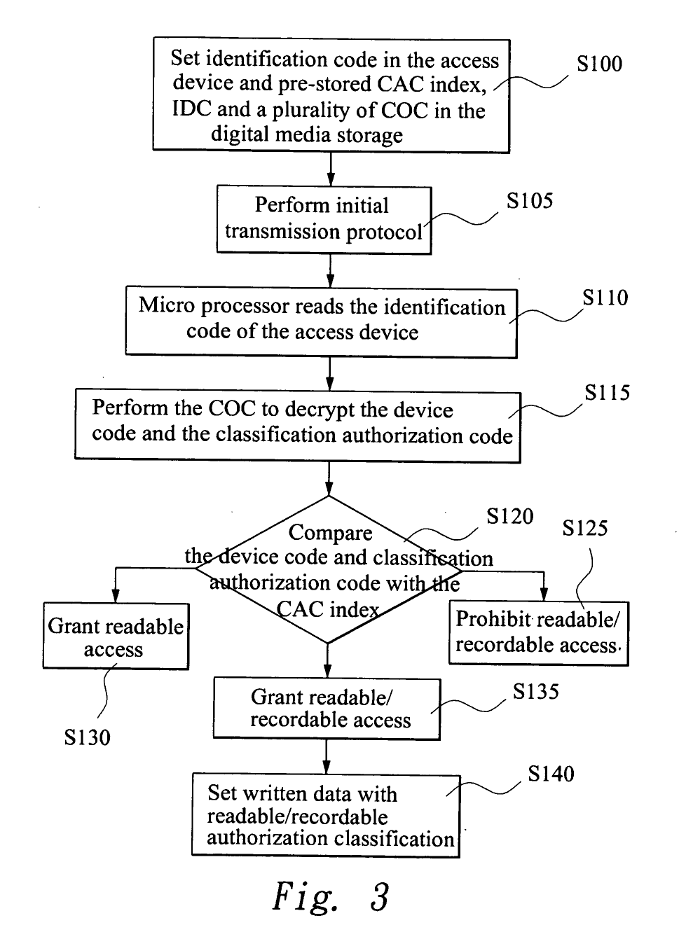

FIG. 3 shows the authorization flowchart of the present invention. An identification code 41 is set in the access device 20. Moreover, CAC index 44, an SIDC 45 and a plurality of Classification Operation Command (COC) 46 are pre-stored in the hidden area 32 of the digital media storage 10 in step S100.

When the digital media storage 10 is connected to the access device 20, or the digital media storage 10 and the access device 20 are turned after connection, the digital media storage 10 and the access device 20 will perform initial transmission protocol in step S105. The readable/recordable right for the access device 20, the transmission rate for both parties and readable/recordable range are determined.

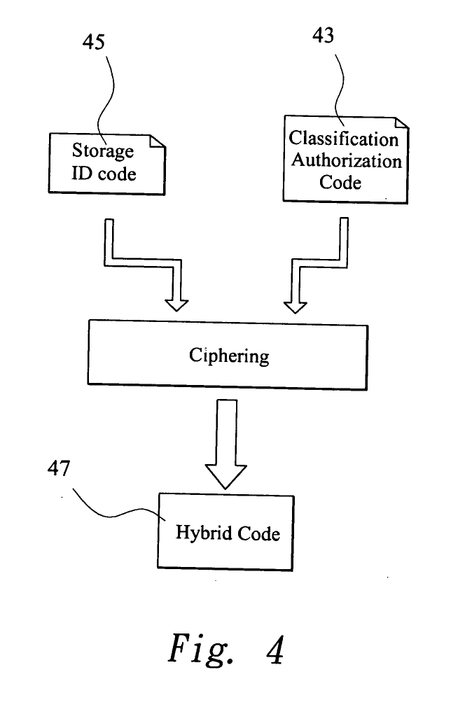

At this time, the micro processor 11 sends the storage ID code 45 to the access device 20 and the micro processor 11 reads the identification code 41 in step S110. Therefore, the device code and the storage ID code 45 can be computed. Because the access device 20 also has computation ability, the storage ID code 45 can be ciphered with the classification authorization code 43 to form a hybrid code 47. FIG. 4 shows the schematic diagram of the hybrid code.

Afterward, it is judged whether the hybrid codes 47 produced by the access device 20 and the micro processor 11 are matched. The access permission is authorized if the hybrid codes 47 are matched; otherwise the readable/recordable area is prohibited from accessing. If the hybrid codes 47 are matched, the micro processor 11 will perform the classification operation command (COC) 46 to decrypt the device code and the classification authorization code 43 in step S115.

The micro processor 11 will compare the device code and classification authorization code 43 with the classification authorization code index (CAC index) 44 in step S120 to determine the readable/recordable authorization classification for the access device 20. The micro processor 11 will grant reading permission for the readable/recordable area 31 in step S130; or grant reading/writing right for the readable/recordable area 31 in step S135; or prohibiting reading/writing right for the readable/recordable area 31 in step S125. The written data is set with readable/recordable authorization classification to protect user's confidentiality in step S140.

For example, according to the present invention, a plurality of SD cards 10 is assigned to a GPS navigator 20 for storing map and navigation software. The device code and classification authorization code 43 is encrypted into an identification code 41 and the identification code 41 is store in the GPS navigator 20. The device code, the classification authorization code 43 and the corresponding read/write authorization classification are stored in the classification authorization code index (CAC index) 44 of the SD cards 10. Unique (non-duplicative) storage ID codes 45 and classification operation command (COC) 46 for SD cards 10 are also stored in the SD cards 10. Afterward, the map and navigation software can then be stored in the GPS navigator 20.

When the SD card 10 is connected to the GPS navigator 20, the digital SD card 10 and the GPS navigator 20 will perform initial transmission protocol. The GPS navigator 20 sends an identification code 41 to the SD card 10. The SD card obtains classification authorization code 43 by computing identification code 41. The SD card 10 sends a classification authorization code 43 to the GPS navigator 20. Both of the SD card 10 and the GPS navigator 20 perform ciphering for the classification authorization code 43 and the storage ID code 45 to obtain a hybrid code 47. The hybrid codes 47 are checked whether they are matched. If the hybrid codes 47 are matched, the SD card 10 performs classification operation command (COC) 46 to decrypt the classification authorization code 43 and the classification authorization code 43 is obtained. The GPS navigator 20 accesses the SD card 10 according to the authorization classification defined in the classification authorization code 43.

According to another preferred embodiment of the present invention, the memory unit 12 is programmed to a plurality of memory blocks with different accessing authority limits. The accessing for the memory blocks is granted depending on the classification authorization code 43. Taking a game memory card of 512M as an example, there is read only memory of 300M for storing main program and read only memory of 150M for storing introduction and animation. The remaining memory of 60M is used to store user saved data such as game scenario, score and treasures.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A authority limit management method for digital media storage, the digital media storage comprising at least one micro processor and at least one memory unit and connected to an access device, the method comprising steps of:
a. pre-storing a classification authorization code index (CAC index) and a plurality of classification operation commands (COC) in the digital media storage and setting an identification code for the access device;
b. performing the classification operation command (COC) to calculate a classification authorization code; and
c. granting an authority limit of the memory unit for the access device according to the classification authorization code.

2. The method as in claim 1, wherein the digital media storage can be memory card, USB storage or hard disk.

3. The method as in claim 2, wherein the memory card can be one of CF (Compact Flash), SM (Smart Media), SD (Secure Digital), MMC (Multi Media Card), xD (xD-Picture Card) or MS (Memory Stick).

4. The method as in claim 1, wherein the micro processor is functioned to control a transmission protocol with the access device.

5. The method as in claim 1, wherein the micro processor is functioned to control an operation and accessing range for the memory unit.

6. The method as in claim 1, wherein the memory unit is a flash memory or a hard disk.

7. The method as in claim 1, wherein the memory unit comprises at least one readable/recordable area and a hidden area, wherein the readable/recordable area stores digital data and the hidden area stores the classification authorization code index (CAC index) and the classification operation command (COC).

8. The method as in claim 7, wherein the readable/recordable can be readable/recordable, readable/non-recordable, or non-readable/non-recordable according to the access authority limit.

9. The method as in claim 1, wherein the access device is a computer with storage media slot, access device with card reader or USB interface controller.

10. The method as in claim 1, wherein the pre-storing operation in step (a) is performed before the digital media storage leaves factory or updated by original manufacturer.

11. The method as in claim 1, wherein the setting operation in step (a) is performed before the digital media storage leaves factory or updated by original manufacturer.

12. The method as in claim 1, wherein the classification authorization code index (CAC index) records device code and classification authorization code for the access devices, the classification operation command (COC) is used to calculate the device code and classification authorization code for the access device.

13. The method as in claim 1, wherein the step a further comprises pre-storing a storage ID code to the digital media storage.

14. The method as in claim 13, wherein the storage ID code is a unique serial number for representing the digital media storage.

15. The method as in claim 13, further comprising the micro processor sending the storage ID code to the access device.

16. The method as in claim 1, wherein the step a further comprises the micro processor reading the identification code of the access device.

17. The method as in claim 1 or 13, further comprising steps after step (a):
the access device and the micro processor simultaneously ciphering the classification authorization code and the storage ID code for generating a hybrid code;
comparing whether the hybrid codes generated by the access device and the micro processor are matched;
performing step (c) when the hybrid codes are matched, else accessing the memory unit is prohibited.

18. The method as in claim 1, wherein the step (b) is performed when the micro processor and the access device are connected for initial transmission protocol.

19. The method as in claim 1, wherein the step (b) is performed when the micro processor and the access device are turned on for initial transmission protocol.

20. The method as in claim 1, wherein the step (b) further comprises
obtaining the classification authorization code and a device code of the access device by calculating the identification code.

21. The method as in claim 20, wherein the device code is used to identify the access device for the digital media storage.

22. The method as in claim 1, further comprising steps after the step (c):
comparing an authority limit for the classification authorization code according to the classification authorization code index (CAC index); and
determining an authority limit of the memory unit for the access device.

23. The method as in claim 1, further comprising steps after the step (c):
the access device accessing data in the readable/recordable area of the memory unit according to the authority limit.

24. The method as in claim 1, further comprising steps after the step (c):
the access device accessing data in the readable/recordable area of the memory unit according to the authority limit; and
setting an authority limit for a data written by the access device into the readable/recordable area of the memory unit.

25. A digital media storage connected to an access device with an identification code, the digital media storage comprising:
at least one memory unit used to store data and pre-stored with an classification authorization code index (CAC index) and a plurality of classification operation commands (COC); and
at least one micro processor performing the classification operation commands (COC) and calculating a classification authorization code according to the identification code of the access device, the micro processor determining an authority limit of the memory unit for the access device according to the classification authorization code and controlling an operation and range for accessing the memory unit.

26. The digital media storage as in claim 25, wherein the digital media storage can be memory card, USB storage or hard disk.

27. The digital media storage as in claim 26, wherein the memory card can be one of CF (Compact Flash), SM (Smart Media), SD (Secure Digital), MMC (Multi Media Card), xD (xD-Picture Card) or MS (Memory Stick).

28. The digital media storage as in claim 25, wherein the access device is a computer with storage media slot, access device with card reader or USB interface controller.

29. The digital media storage as in claim 25, wherein the identification code is formed by encrypting a device code for representing the access device and a classification authorization code for representing an authority limit of the access device.

30. The digital media storage as in claim 25, wherein the memory unit is a flash memory or a hard disk.

31. The digital media storage as in claim 25, wherein the memory unit comprises at least one readable/recordable area and a hidden area, wherein the readable/recordable area stores digital data and the hidden area stores the classification authorization code index (CAC index) and the classification operation command (COC).

32. The digital media storage as in claim 31, wherein the hidden area is pre-stored with a storage ID code, and the storage ID code is a unique serial number for representing the digital media storage.

33. The digital media storage as in claim 31, wherein the classification authorization code index (CAC index) records device code and classification authorization code for the access device.

34. The digital media storage as in claim 31, wherein the classification operation command (COC) is used to calculate the device code and classification authorization code for the access device.

35. The digital media storage as in claim 31, wherein the readable/recordable can be readable/recordable, readable/non-recordable, or non-readable/non-recordable according to the authority limit.

36. The digital media storage as in claim 25, wherein the micro processor is used to control a transmission protocol for the access device connected to the digital media storage.

37. The digital media storage as in claim 36, wherein the transmission protocol includes that the micro processor reads the identification code of the access device.

38. The digital media storage as in claim 36, wherein the transmission protocol includes that the micro processor performs the classification operation command (COC) and decrypt an device code and the classification authorization code according to the identification code.

39. The digital media storage as in claim 36, wherein the transmission protocol includes that the micro processor sends a storage ID code to the access device; both the micro processor and the access device cipher the classification authorization code and the storage ID code to a hybrid code, the hybrid codes of the micro processor and the access device are compared; the authority limit of the memory unit is granted when the hybrid codes are matched; the accessing of the readable/recordable area is prohibited when the hybrid codes are not matched.

40. The digital media storage as in claim 36, wherein the transmission protocol includes that the classification authorization code is compared with the classification authorization code index (CAC index) to determine the authority limit of the memory unit for the access device.
